(19) United States
(12) Patent Application Publication
(10) Pub. No.: US 2009/0219254 A1
(43) Pub. Date: Sep. 3, 2009

(54) NOTEBOOK COMPUTER WITH DUAL SCREENS

(75) Inventors: HSIU-CHANG LAI, Tu-Cheng (TW); MING-KE CHEN, Shenzhen (CN); KE SUN, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/100,379

(22) Filed: Apr. 9, 2008

(30) Foreign Application Priority Data
Mar. 3, 2008 (CN) 200810300448.X

(51) Int. Cl. G06F 3/041; G09G 5/00

(52) U.S. Cl. 345/173; 345/1.3

(57) ABSTRACT

A notebook computer with dual screens includes a first display screen, a second display screen has a touch screen function, a motherboard includes a north bridge and a south bridge, a super input/output device, a touch screen control circuit is connected to the south bridge through the super input/output device, a channel selection circuit is connected to an output of the touch screen control circuit, first and second signal selection circuits are respectively connected to two outputs of the channel selection circuit via a switch, and a video card with dual ports. The first and second display screens are respectively connected to the first and second signal selection circuits. The two ports of the video card are connected to the first and second signal selection circuits. An input of the video card is connected to the motherboard.

### BACKGROUND OF THE INVENTION

1. Field of the Invention

The present invention relates to a notebook computer with dual screens.

2. Description of Related Art

Generally, personal computers can be classified into desktop computers, notebook computers etc. Notebook computers are thin and lightweight. Therefore, notebook computers are very popular since they provide considerable convenience. The convenience and transportability of the notebook computers have created a large and lucrative market for manufacturers of such machines.

Nowadays, some factories manufacture a sideshow notebook computer with two screens. The sideshow notebook computer has a conventional display screen and an auxiliary screen embedded in the lid of the sideshow notebook computer. Users can check e-mail and calendar appointments, view pictures, choose a song from a music library via the auxiliary screen etc. However, the auxiliary screen is small with only a few simple functions.

What is needed, therefore, is a notebook computer with dual screens and greater functionality.

### SUMMARY

An exemplary notebook computer with dual screens includes a first display screen, a second display screen which has a touch screen function, a motherboard which includes a north bridge and a south bridge, a super input/output device, a touch screen control circuit which is connected to the south bridge through the super input/output device, a channel selection circuit which is connected to an output of the touch screen control circuit, first and second signal selection circuits which are respectively connected to two outputs of the channel selection circuit via a switch, and a video card with dual ports. The first and second display screens are respectively connected to the first and second signal selection circuits. The two ports of the video card are connected to the first and second signal selection circuits. An input of the video card is connected to the motherboard.

Other advantages and novel features will become more apparent from the following detailed description when taken in conjunction with the accompanying drawings, in which:

### BRIEF DESCRIPTION OF THE DRAWINGS

FIG. 1 is a perspective view of one embodiment of a notebook computer with dual screens in accordance with the present invention;

FIG. 2 is a perspective view of the notebook computer of FIG. 1, viewed from an opposite aspect; and

FIG. 3 is a circuit diagram of the notebook computer of FIG. 1.

### DETAILED DESCRIPTION

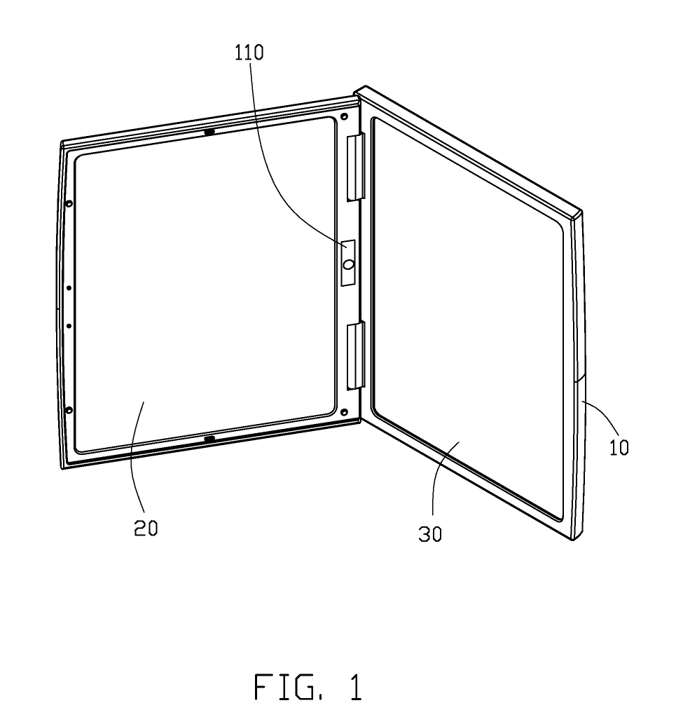

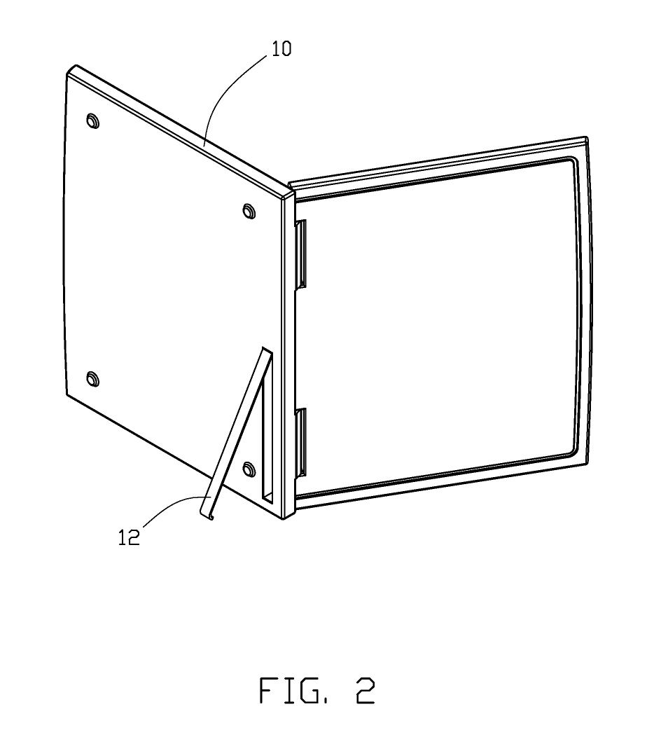

Referring to FIGS. 1 and 2, a notebook computer with dual screens in accordance with an embodiment of the present invention includes a main body 10, a main display screen 20 pivotably coupled to an end portion of the main body 20, an auxiliary screen 30 embedded in the lid of the main body 10. The main display screen 20 is a conventional LCD screen. The auxiliary screen 30 is a touch screen. The auxiliary screen 30 is configured to form a virtual keyboard.

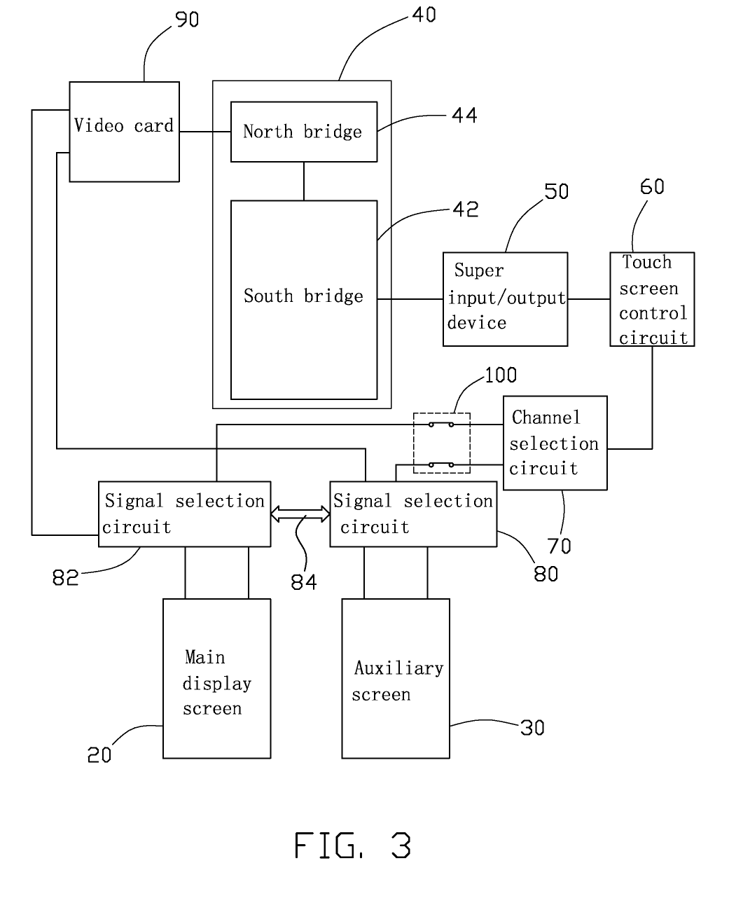

Referring to FIG. 3, in the main body 10, there are a central processing unit (CPU), a hard disk drive, a motherboard 40, a super input/output device 50, a touch screen control circuit 60, a channel selection circuit 70, a first signal selection circuit 80, a second signal selection circuit 82, a video card with dual ports 90, and a switch 100. The motherboard 40 includes a south bridge 42 and a north bridge 44.

The south bridge 42 is connected to an input of the super input/output device 50. An output of the super input/output device 50 is connected to an input of the channel selection circuit 70 via the touch screen control circuit 60. An output of the channel selection circuit 70 is connected to an input of the first signal selection circuit 80 and an input of the second signal selection circuits 82 via the switch 100. An output of the first signal circuit 80 is connected to the auxiliary screen 30. An output of the second signal circuit 82 is connected to the main display screen 20. The north bridge 44 is connected to an input of the video card 90. Two ports of the video card 90 are respectively connected to the first and second signal selection circuits 80 and 82. The first signal circuit 80 communicates to the second signal circuit 82 via an inter-integrated circuit bus 84.

When the notebook computer is booted up, the super input/output device 50 starts the touch screen control circuit 60. And the switch 100 turns on. The auxiliary screen 30 is actuated via the channel selection circuit 70 and the signal selection circuit 80, and forms a virtual keyboard. Users can operate the notebook computer using the virtual keyboard.

If users need no keyboard, for example, when users watch a video, the switch 100 is turned off via a button 110 located at the main body 10. And the channel selection circuit 70 is disconnected from the signal selection circuits 80 and 82. The signal selection circuits 80 and 82 receive signals from the video card 90. As a result, users can set parameters of the video card 90 to display the video on the main display screen 20 and the auxiliary screen 30 simultaneously. In other embodiment, users can also turn off the switch 100 via a predefined hot key on the virtual keyboard.

If users need to use the virtual keyboard when they watch a video, they can turn on the switch 100 by depressing the button 110, activating the channel selection circuit 70, and the signal selection circuits 80, 82. As a result, the touch control circuit 60 is connected to the auxiliary screen 30, and the auxiliary screen 30 returns to the virtual keyboard mode.

In this embodiment, the notebook computer further includes a bracket 12 pivotably mounted to a rear side of the main body 10 of the notebook computer. The bracket 12 is pivotable between a first position in which the bracket 12 is accommodated in a recess of the rear side and a second position in which the bracket 12 is angled from the rear side to support the main screen 20 and the auxiliary screen 30.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternately embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A notebook computer with dual screens comprising:
A first display screen and a second display screen having a touch screen function;
a motherboard comprising a north bridge and a south bridge;
a super input/output device;
a touch screen control circuit, the touch screen control circuit connected to the south bridge through the super input/output device;
a channel selection circuit connected to an output of the touch screen control circuit;
a first signal selection circuit and a second signal selection circuit respectively connected to two outputs of the channel selection circuit via a switch, the first and second display screens respectively connected to the first and second signal selection circuits; and
a video card with dual ports, the two ports of the video card connected to the first and second signal selection circuits, an input of the video card connected to the motherboard, wherein when the switch turns on, the super input/output device starts the touch screen control circuit to control the touch screen form a virtual keyboard; when the switch turns off, the first and second signal selection circuits receive the signal from the video card for display of the first and second display screens.

2. The notebook computer as claimed in claim 1, wherein the virtual keyboard comprises a predefined hot key, the predefined hot key is configured to control the switch.

3. The notebook computer as claimed in claim 1, further comprising a button associating with the switch, and configured to control the switch.

4. The notebook computer as claimed in claim 1, further comprising a bracket mounted to a rear side of the main body of the notebook computer, wherein the bracket is pivotable between a first position in which the bracket is accommodated in a recess of the rear side and a second position in which the bracket is angled from the rear side to support the first and second display screen.

5. The notebook computer as claimed in claim 1, wherein the first signal selection circuit is connected to the second signal selection circuit via an inter-integrated circuit bus.
